(19) United States
(12) Patent Application Publication
(10) Pub. No.: US 2026/0302574 A1
(43) Pub. Date: Oct. 1, 2026

(54) ELECTRIC VEHICLE BATTERY COOLANT DRAIN DEVICE

(71) Applicant: NEW FLYER INDUSTRIES CANADA ULC, Winnipeg (CA)

(72) Inventors: Thomas Evan SMALL, Winnipeg (CA); Paul Joseph George CANTIN, Lorette (CA); Martin SCHULZE, Libau (CA); Fraser ISAAC, Kleefeld (CA); Brent MATTHEWS, Winnipeg (CA)

(21) Appl. No.: 19/478,702

(22) PCT Filed: May 3, 2024
(86) PCT No.: PCT/IB2024/054336

§ 371 Date: Oct. 24, 2025

Related U.S. Application Data
(60) Provisional application No. 63/465,134, filed on May 9, 2023.

(51) Int. Cl. H01M 50/645; B60L 50/64; B60L 58/26; F16K 31/12; H01M 10/6567

(52) U.S. Cl. CPC H01M 50/645; B60L 50/64; F16K 31/12; H01M 10/6567; B60L 58/26; H01M 2220/20

(57) ABSTRACT

The present specification provides an electric bus battery cooling system, method and apparatus. Notably, the specification contemplates a coolant drain valve for an electric vehicle energy storage system. The coolant drain valve comprising a crown and ejector, the ejector cooperating with a liquid sensitive medium to eject the crown from a flow outlet in order to drain leaking coolant from the battery.

### BACKGROUND

Electric buses are an important step towards the goal of a low-carbon society. The transition from fossil fuel vehicles to electric vehicles has been and continues to be long and challenging. A significant barrier has been the technology to provide stable battery technologies that can store enough energy to power a large electric bus for substantially equivalent ranges as conventional fossil fuel buses. Fleets of electric buses are now beginning to enter service, as lithium-based batteries have proven a viable means for energy storage. However, lithium batteries can pose significant fire hazards and need to have sophisticated custom electronics and control systems in order to fit the form-factor of the bus and to properly interface with the bus's electric powertrain. These and other challenges continue to present a barrier to adoption of electric buses.

Cooling systems are an important component to mitigate risks of fire and overall manage the health of the battery, but management of coolant including leaking coolant has its own challenges. Coolant which leaks into sensitive regions of the battery can lead to dangerous chemical reactions, short circuiting and thermal runaway. U.S. Pat. No. 9,899,652 proposes a method and device for helping to drain the coolant from battery in leaking situations, and yet risks remain.

### SUMMARY

An aspect of the specification provides an assembly for a drain valve for an energy storage subsystem (ESS) including: a crown for releasable sealing engagement within a flow outlet; an ejector coupled to the crown; a liquid-sensitive medium to cooperate with the ejector; and, a biasing means to cooperate with the liquid-sensitive medium and the ejector in order to: maintain the crown in the sealing engagement when the liquid-sensitive medium is dry; and release the crown from the sealing engagement when the liquid-sensitive medium is wet.

An aspect of the specification provides an assembly wherein the crown is ejectable from the flow outlet when released.

An aspect of the specification provides an assembly wherein the crown, ejector, liquid sensitive medium and biasing means are ejectable from the flow outlet when the crown is released.

An aspect of the specification provides an assembly wherein the ejector includes a pin depending from the crown having a dome on the end of the pin opposite from the crown.

An aspect of the specification provides an assembly wherein the ejector includes a bobbin surrounding the pin and having a diameter less than the dome in order to maintain the crown in sealing engagement; the liquid sensitive medium within a core of the bobbin; the bobbin including a plurality of tabs biased towards the periphery of the bobbin, such that when the liquid sensitive medium is dry the tabs secure the dome in order to maintain the crown, and when the liquid-sensitive medium is wet the medium loses structural integrity and the tabs bias towards the periphery and release the crown.

An aspect of the specification provides an assembly wherein the biasing means is a helical spring disposed around the pin and having a first end that abuts the crown.

An aspect of the specification provides an assembly wherein the ejector includes a collar slidable along the pin and retained between the dome and the spring.

An aspect of the specification provides an assembly wherein the spring has a compressed position to maintain the crown within the outlet and a less-compressed position to release the crown and at least partially eject the crown from the outlet.

An aspect of the specification provides an assembly wherein the dome has a retracted position in relation to the collar to release the crown and an extended position in relation to the collar to maintain the crown.

An aspect of the specification provides an assembly wherein the crown includes at least one O-ring for the sealing engagement.

An aspect of the specification provides an assembly wherein the flow outlet is part of a bushing that has a threaded end for securing the case of the ESS.

An aspect of the specification provides an assembly further including an O-ring on the periphery of the threaded end abutting the flow outlet.

An aspect of the specification provides an assembly further including a tether for securing at least the crown to the flow outlet upon ejection of the crown.

An aspect of the specification provides a method for draining coolant from an energy storage sub-system (ESS) including: sealing a flow outlet in the ESS with a crown; maintaining the crown within the flow outlet via an ejector cooperating with a liquid-sensitive medium; releasing the crown from the flow outlet via the ejector upon detecting a coolant within the liquid-sensitive medium; ejecting the crown from the flow outlet; and, expelling coolant from the flow outlet without obstruction from the crown.

An aspect of the specification provides a method further including ejecting the ejector and expelling coolant without obstruction from the release.

An aspect of the specification provides a method wherein the ejector cooperates with a biasing means for the maintaining and the releasing.

An aspect of the specification provides the method 16 wherein the ejector includes a pin depending from the crown having a dome on the end of the pin opposite from the crown.

An aspect of the specification provides a method wherein the ejector includes a bobbin surrounding the pin and having a diameter less than dome in order to maintain the crown; the liquid sensitive medium within a core of the bobbin; the bobbin including a plurality of tabs biased towards the periphery of the bobbin, such that when the liquid sensitive medium is dry the tabs secure the dome in order to maintain the crown, and when the liquid-sensitive medium is wet the medium loses structural integrity and the tabs bias towards the periphery and release the crown.

An aspect of the specification provides a method further including securing the crown to the outlet with a tether.

An aspect of the specification provides a drain valve system for an energy storage sub-system (ESS) including: a bushing having a mounting end for attachment to an ESS casing; the bushing having a flow outlet opposite the mounting end; a piston assembly having a crown for releasable sealing engagement with the flow outlet; a pin depending from the crown; a dome at the end of the pin opposite the crown; the piston assembly further having a helical spring surrounding the pin and disposed between the crown and the dome; the piston assembly further having a collar slidable along the pin and retained between the spring and the dome; a toroidal bobbin disposed within the mounting end and having a liquid-sensitive medium in the core of the bobbin; the toroidal bobbin surrounding and securing the pin and dome and compressing the spring when the liquid-sensitive medium is dry; the toroidal bobbin releasing the dome and pin when the liquid-sensitive medium loses structural integrity when it becomes wet, allowing the spring to relax and unfastening the crown to unseal the flow outlet; and, a tether for securing the piston assembly to the bushing when the piston assembly is ejected from the flow outlet and fluid flows via the flow outlet without obstruction by the piston assembly.

### BRIEF DESCRIPTION OF THE FIGURES

FIG. 1 is a perspective view of the chassis and power supply system of an electric bus.

FIG. 2 shows a perspective view of one of the energy storage subsystems (ESSs) of FIG. 1 in greater detail.

FIG. 3 shows a top view of one of the ESSs of FIG. 1.

FIG. 4 shows a portion of the ESS in greater detail to highlight one possible location of drain valves.

FIG. 5 shows an enlarged perspective view of the drain valve in isolation from the ESS.

FIG. 6 shows an exploded view of the drain valve.

FIG. 7 shows the bobbin of FIG. 6.

FIG. 8 shows a sectional view of a portion of the ESS and the drain valve in the sealed state.

FIG. 9 shows a sectional view of a portion of the ESS and the drain valve in the unsealed state.

FIG. 10 shows a sectional view of a portion of the ESS and the drain valve in the sealed state.

FIG. 11 shows another sectional view of a portion of the ESS and the drain valve in the unsealed state.

FIG. 12 shows the egress of fluid from the ESS when the piston assembly is ejected.

FIG. 13 shows another view of the egress of fluid from the ESS when the piston assembly is ejected.

### DETAILED DESCRIPTION

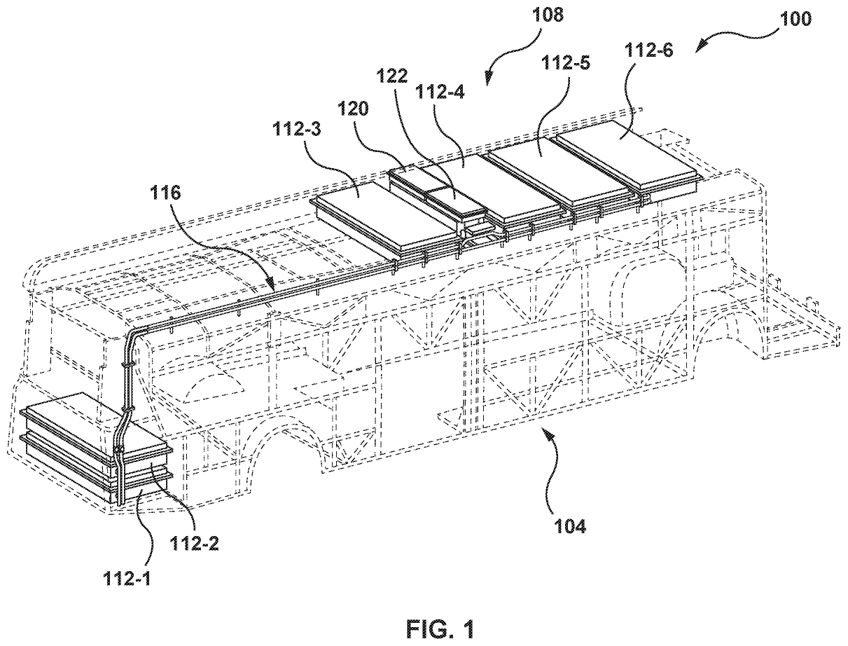

FIG. 1 shows a portion of an electric bus 100 in the form of a bus chassis 104 (shown in dotted lines) and a power supply system 108 (shown in solid lines). Power supply system 108 comprises a plurality of energy storage sub-systems 112-1, 112-2, 112-3, 112-4, 112-5, 112-6. (Collectively, energy storage sub-systems 112-1, 112-2 . . . 112-n are referred to as energy storage sub-systems 112 or ESSs 112, and generically, as energy storage sub-system 112 or ESS 112. This nomenclature is used elsewhere herein.) ESSs 112 are colloquially referred to as batteries or battery packs, but the term ESS may be preferred given that the term “battery” may arise in other contexts of an electric vehicle. Power supply system 108 also comprises a cooling subsystem 116 and at least one vehicle controller 120 and a Battery Thermal Management System (BTMS) 122.

It is to be understood that the form factor of electric bus 100 is non-limiting and the locations, number and sizes and other form factor variables for the above-mentioned components can be vary across different types of busses which can benefit from the teachings of the present specification. Furthermore, while not shown in FIG. 1, bus 100 also includes a powertrain in the form of one or more electric motors that drive one or more the wheels of the bus. It is contemplated that the powertrain can vary across different busses that are variants of bus 100. Vehicle controller 120 can thus be configured to regulate the transfer of energy from ESSs 112 to the powertrain according to the control signals issued from the accelerator and brake as operated by the driver, and may optionally include other sensors on the bus such as global positioning system (GPS), cameras and lidar that can be directed to, for example, automatically applying brakes to the bus 100 in the event a hazard is detected. Controller 120 can also be configured to control regenerative braking thereby directing energy back into the ESSs 112. Controller 120 can also be configured to connect bus 100 to an external power supply to charge ESSs 112.

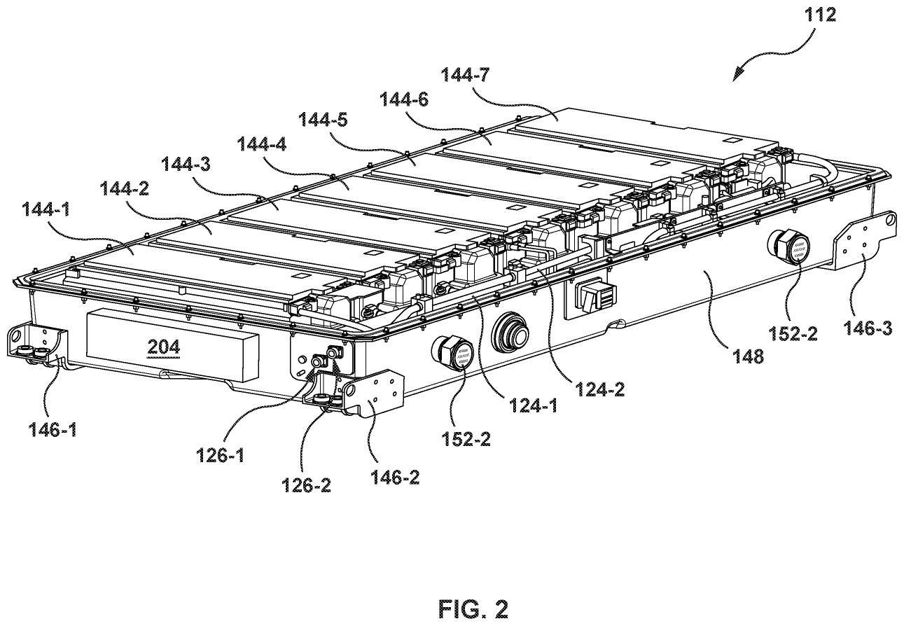

FIG. 2 shows an example of the interior of an example ESS 112 in greater detail. In FIG. 2, ESS 112 comprises a plurality of battery modules 144, which are in the present example are lithium-ion. Coolant lines 124 are shown as passing through the interior of ESS 112, connected to coolant ports 126 on a casing 148. (Coolant ports 126 comprise an inlet coolant port 126-1 and an outlet coolant port 126-2 respective to each line 124). Mounting brackets 146 are disposed on each corner of the casing 148 for securely mounting ESS 112 to chassis 104. A plurality of coolant drain valves 152 are also provided. In a present embodiment, four coolant drain valves 152 are provided, one at each corner of the ESS 112. However, in other embodiments, a different number of drain valves 152 may be provided. Drain valves 152 will be discussed in greater detail below, but in general terms, drain valves 152 allow for rapid drainage of coolant in the event of an internal coolant leak which, at a significant volume, can cause an increased risk of initiating a thermal runaway event.

In FIG. 2, ESS 112 also includes a battery control unit 204 that cooperates with vehicle controller 120 (of FIG. 1) and BTMS 122 (of FIG. 1) to monitor overall battery health, including charging, discharging, and temperature. BTMS 122 can be implemented using a programmable logic controller (PLC) or variant thereon, however the specific type of controller or implementation is not particularly limited. Battery control unit 204 can also moderate or control charging and discharging rates according to pre-defined safe operating parameters, and can also moderate or control temperature through management of coolant flow through coolant lines 124. Battery control units 204 can also include emergency shut off functions, in the event any safety parameter is violated such as overheating or fire. Thus, battery control units 204 can be integral with each ESS 112 and include one or more override switches, temperature sensors, voltage sensors, current sensors, charge level sensors, current modulators, voltage modulators, and coolant flow regulators.

FIG. 2 shows an example form factor for ESS 112 but it is to be understood that the present specification contemplates different form factors. For example, the form factor for ESS 112, the modules 144 and coolant lines 124, can vary across bus 100 or across different variations of bus 100. Furthermore, the contents of a given casing for a given ESS 112 can vary, with different configurations, types, and numbers of modules 144 being included. Or, the modules 144 across different ESSs 112 can be the same type, but at different stages in their life-cycle. Overall, according to the present specification, a heterogenous or hybrid combination of ESSs 112 can be installed in bus 100 and/or across a fleet of busses. Furthermore, as noted, fewer or additional drain valves 152 may be provided.

As seen in FIG. 1, the power system 108 of bus 100 also includes at least one vehicle controller 120. Vehicle controller 120 can be based on any standard or known control device (or a plurality of devices) used for delivering energy from power system 108 to drive bus 100, such as sending electrical energy to the powertrain, and to accessories such as lighting systems; environmental controls such as heating, ventilation and air-conditioning; door control; and lighting. Vehicle controller 120 can also moderate charging of ESSs 112.

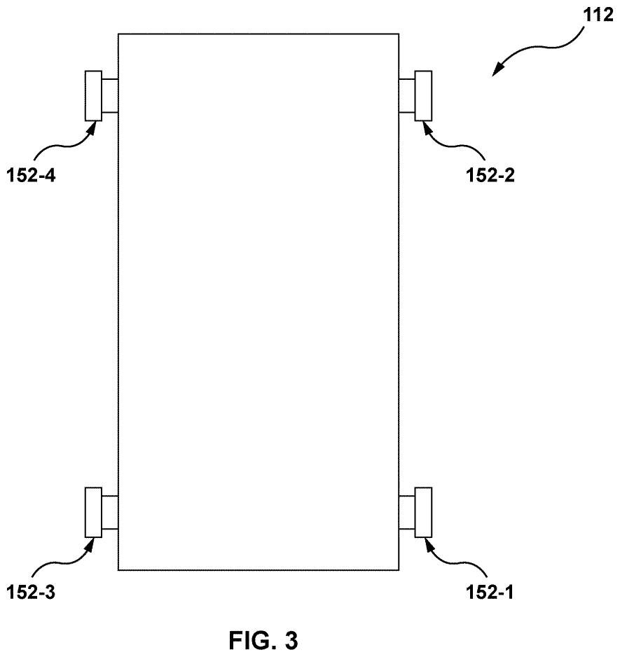

FIG. 3 shows a top schematic view of ESS 112, in order to illustrate presently preferred locations for each drain valve 152. Again, the number and locations drain valves 152 are not particularly limited.

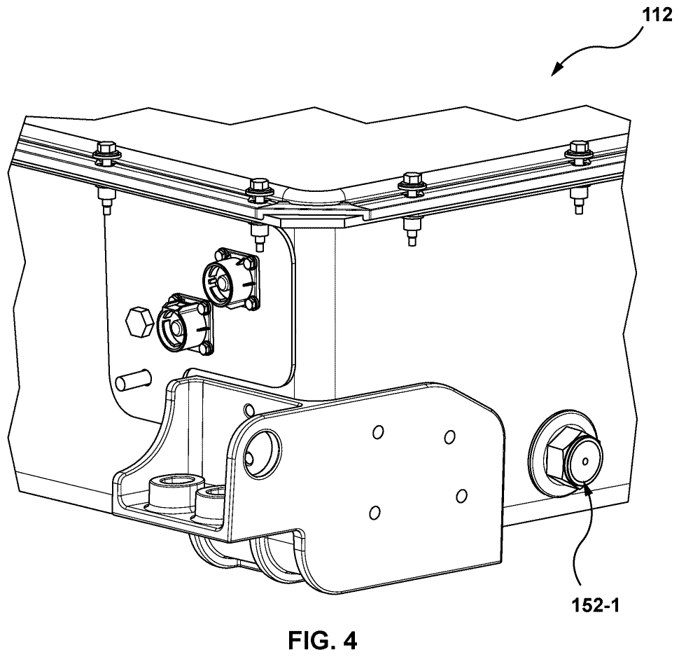

FIG. 4 shows a portion of ESS 112 in greater detail to highlight one possible location of drain valves 152 in the corner of ESS 112.

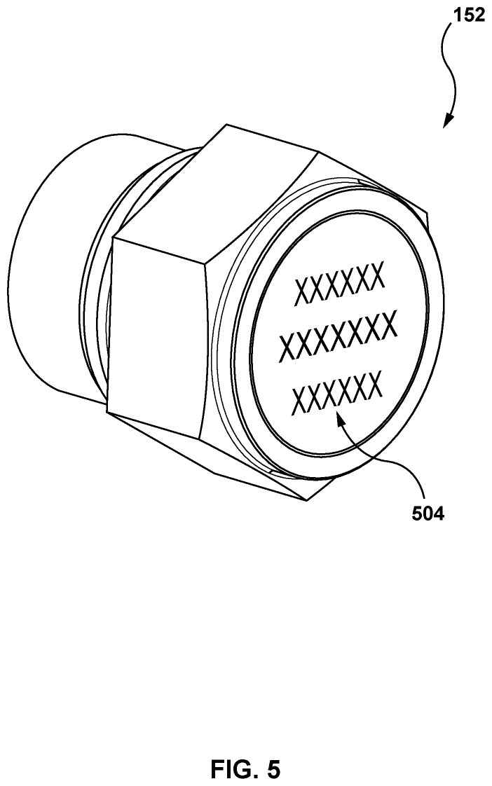

FIG. 5 shows an enlarged perspective view of valve 152 in isolation from ESS 112. As shown in FIG. 5, drain valve 152 can include an identifier 504, such as a serial number, which can be used to uniquely identify each drain valve 152 from the other for quality control and other auditing purposes.

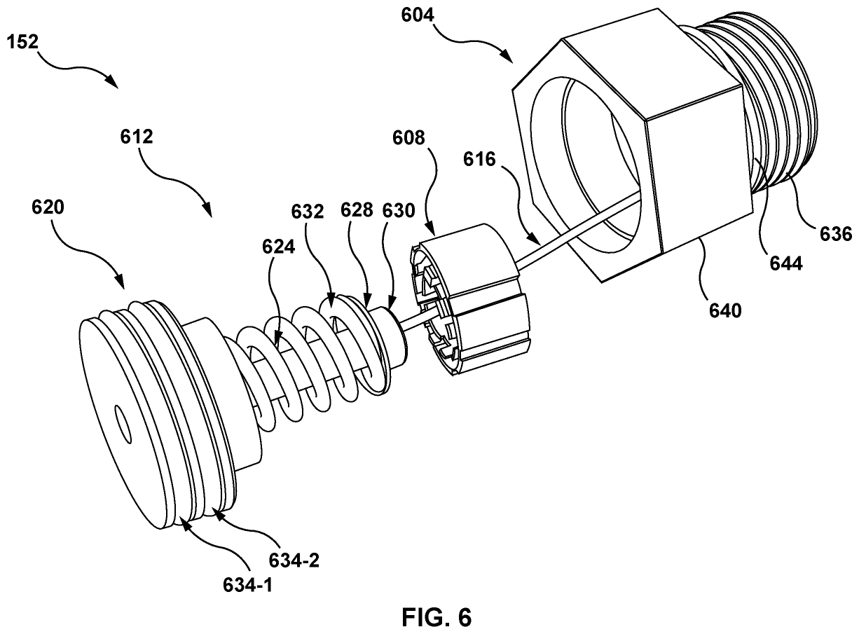

FIG. 6 shows an exploded view of drain valve 152. Each valve 152 comprises a bushing 604, a bobbin 608, and a piston assembly 612, all of which are strung together by a tether 616.

Bushing 604 includes a threaded end 636, (best seen in FIG. 6) which in a present embodiment includes male threads that are complementary to a female threaded socket (not shown in FIG. 6) on one of the four appropriate corresponding locations of ESS 112. Bushing 604 also includes a flow outlet 640 opposite threaded end 636. As the name describes, coolant can exit from the centre of outlet 640 when piston assembly 612 is removed. In a present embodiment, flow outlet 640 has a hexagonal-periphery, so that a wrench can be used to tighten threaded end 636 within ESS 112 and thereby secure bushing 604 to ESS 112. An o-ring 644 is provided on the exterior of threaded end 636 to about the transition between threaded end 636 and flow outlet 640 to further reduce the risk of leaks. A person of skill in the art will appreciate that bushing 604 can be implemented with mechanical equivalents that attach to ESS 112 at one end and have a flow outlet at the other.

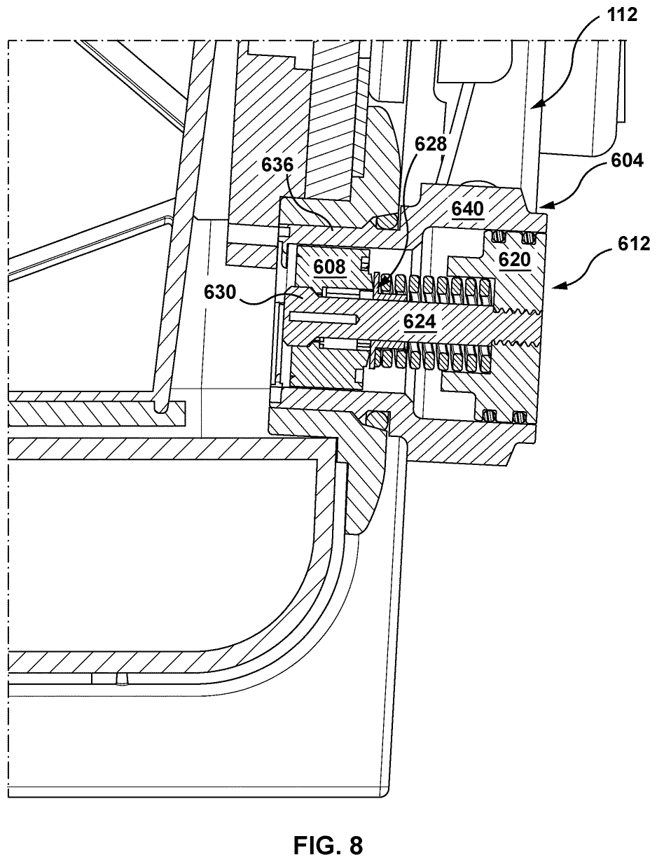

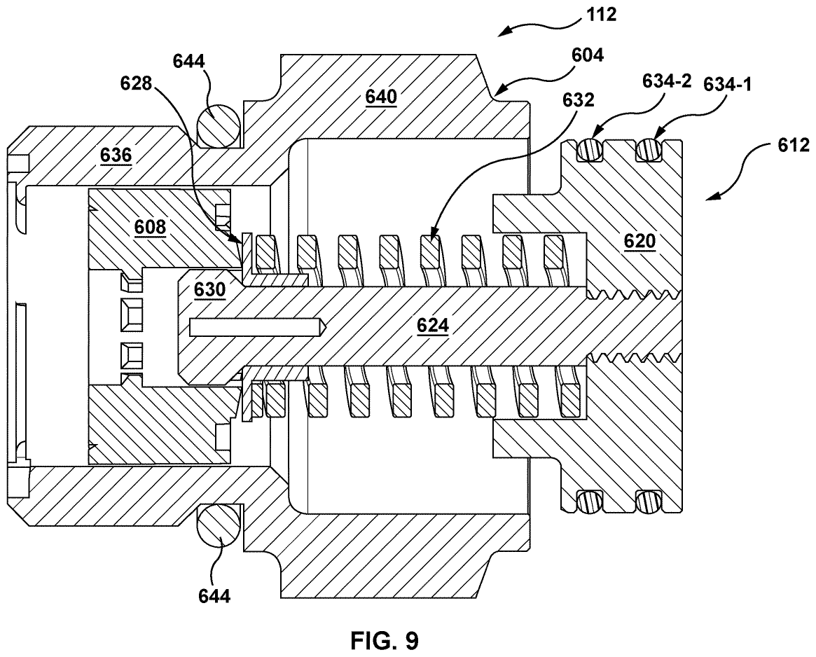

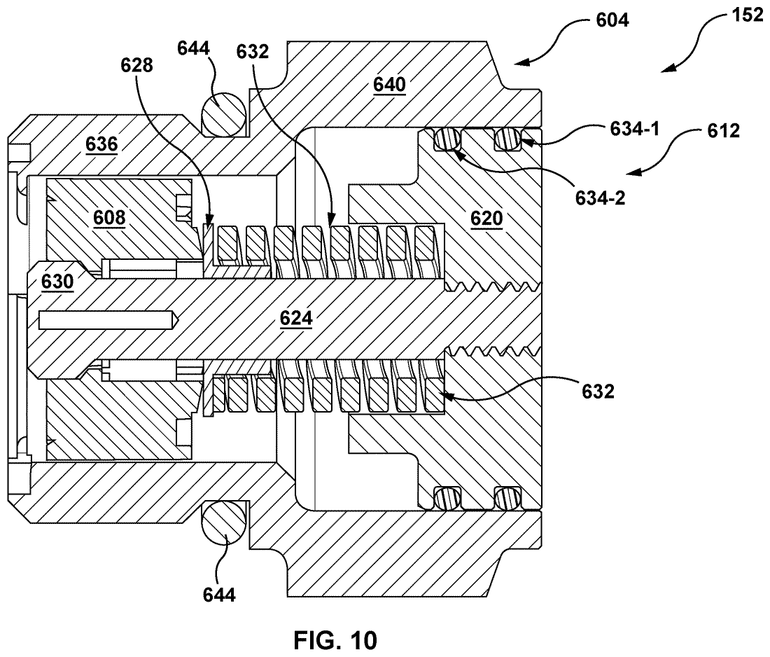

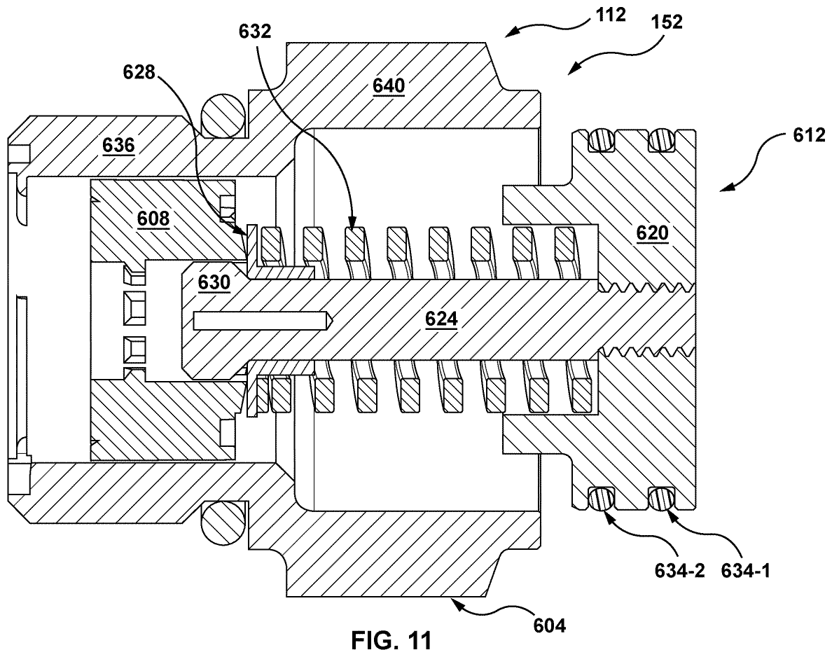

As best seen in FIG. 6, FIG. 8, FIG. 9, FIG. 10 and FIG. 11, piston assembly 612 includes a crown 620 and a pin 624 disposed coaxially with the centre of crown 620. A slidable collar 628 is disposed circumferentially around the end of pin 624 opposite crown 620. A dome 630 defines the end of pin 624 opposite crown 620. Dome 630 has a diameter slightly larger than the hole diameter of collar 628, thereby retaining collar 628 on pin 624 while allowing collar 628 to slide along the length of pin 624. Dome 630 can travel between: i) an extended position relative to collar 628, as shown in FIG. 8 and FIG. 10; and, ii) a retracted position relative to collar 628 shown in FIG. 9 and FIG. 11.

As best seen in FIG. 8 and FIG. 10, in the extended position, crown 620 sits inside flow outlet 640 of bushing 604 providing a seal. As best seen in FIG. 9 and FIG. 11, in the retracted position, crown 620 protrudes from the end of flow outlet 640 of bushing 604, allowing fluid communication from within ESS 112 and its exterior.

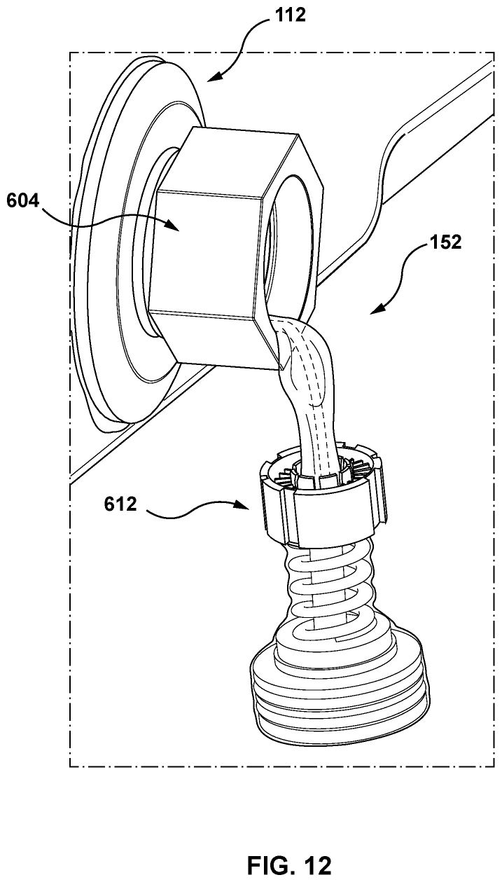

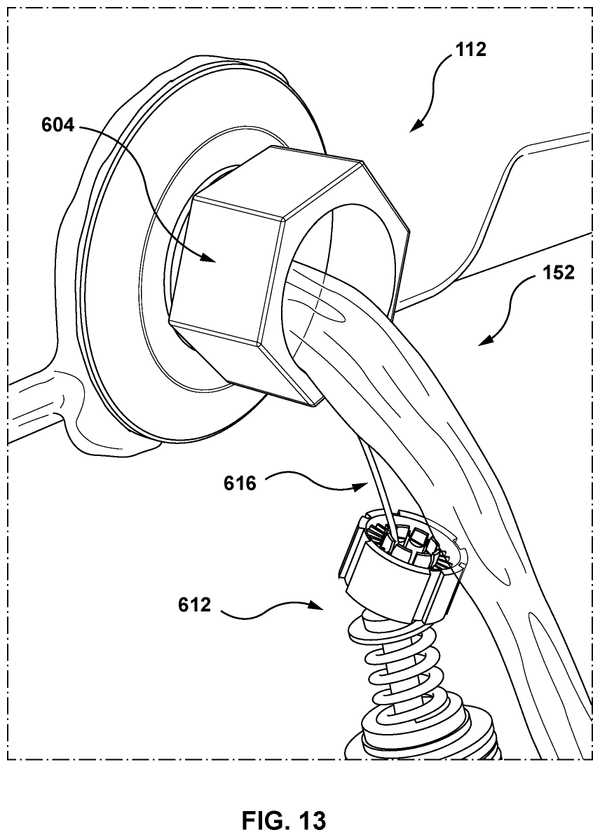

As best seen in FIGS. 12 and 13, the ejection of the entire piston assembly 612 to the outside of ESS 112 provides the full diameter of bushing 604 for egress of fluid. As best seen in FIG. 13, tether 616 retains piston assembly 612 to bushing 604, but piston assembly 612 itself does not meaningfully obstruct fluid egress.

To reiterate, the “retracted position” (FIG. 9, FIG. 11) refers to the fact that the dome 630 is “retracted” in relation to collar 628, but at the same time the “retracted position” allows drain valve 152 to be ejected from ESS 112 (FIG. 12, FIG. 13). Likewise, the “extended position” (FIG. 8, FIG. 10) refers to the fact that dome 630 is “extended” in relation to collar 628, but at the same time the “extended position” retains crown 620 within bushing 604, sealing ESS 112. The “retracted position” as described corresponds to fluid egress, while the “extended position” as described corresponds to a fluid seal.

The “retracted position” and the “extended position” are under the influence of a spring 632. Spring 632 surrounds pin 624, with one end abutting crown 620 and the other abutting collar 628. Spring 632 has a “neutral position” that: i) urges crown 620 away from collar 628, while: ii) urging dome 630 towards collar 628, thereby placing dome 630 in the “retracted position”, as per FIG. 9 and FIG. 11. Conversely, when spring 632 is placed in a “compressed position”: i) crown 620 is disposed closer to collar 628, while: ii) dome 630 is disposed away from collar 628, thereby placing dome 630 in the “extended position”, as per FIG. 8 and FIG. 10.

A pair of gaskets 634, implemented in the present embodiment as O-rings, surround the crown 620 to provide a sealing engagement between crown 620 and flow outlet 640, as shown in FIG. 8 and FIG. 10. Note that fewer or more gaskets 634 are contemplated. Indeed, depending on the materials chosen and desired sealing tolerances, it is possible that gaskets 634 may be obviated altogether. In general, crown 620 and flow outlet 640 are mechanically configured to cooperate to in order to provide a seal. Thus these and other variants are contemplated.

Piston assembly 612, in general terms, serves as a plug when inserted into bushing 604. Piston assembly 612 can be held in place by the friction of the gaskets 634 between crown 620 and flow outlet 640. The triggering performance of the drain valve 152 in various environmental conditions and temperature range can be adjusted by the specific friction achieve through treatments and precise dimensional tolerances applied to crown 620 and flow outlet 640, thereby retaining coolant within ESS 112 and restricting fluid egress. When the plug is removed, fluid egress is possible. This aspect of bobbin 608 will be discussed further below.

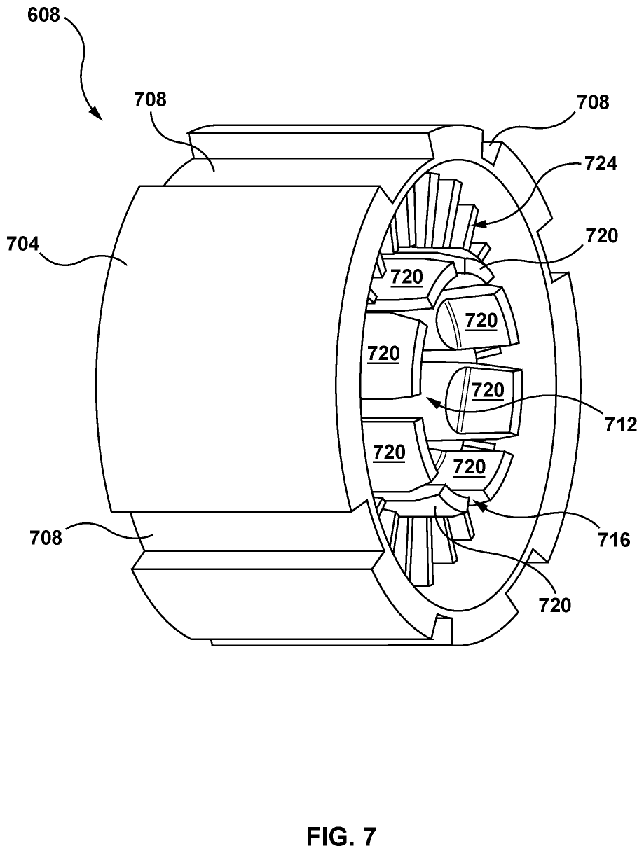

Bobbin 608 is shown in greater detail in FIG. 7, but may also be seen in FIG. 6, FIG. 8, FIG. 9, FIG. 10, FIG. 11, FIG. 12 and FIG. 13. Bobbin 608 has a ring-shaped housing 704 with a plurality of keyed channels 708 on the periphery of housing 704. Channels 708 can allow for fluid communication between the interior of ESS 112 and the interior passageway of flow outlet 640. The interior channel 712 of bobbin 608 is defined by an inner circumference 716. Inner circumference 716 is comprised of a plurality of resiliently deformable tabs 720 that are affixed to housing 704 at one end and individually terminate, floating, at the opposite end of housing 704. (This opposite end with the floating tabs 720 is best seen in FIG. 7.) Each tab 720 is biased towards the periphery of housing 704. A dissolvable band 724 is nested between tabs 720 the periphery of housing 704. If band 724 has not been exposed to liquid, then band 724 maintains its shape and integrity and urges tabs 720 away from the periphery of housing 704 and towards interior channel 712. Accordingly, in this state, as best seen in FIG. 8 and FIG. 10, bobbin 608 can secure dome 630 and thereby act against the expansive force of spring 632 and maintain dome 630 in the extended position. In this state, crown 620 remains engaged within flow outlet 640, placing drain valve 152 into a sealed state which in turn, seals ESS 112.

In general terms, bobbin 608 attaches to dome 630 in order to maintain spring 632 into the compressed position and hold dome 630 in the extended position relative to collar 628. Bobbin 608 has clamp arms or tabs 720 that hold the enlarged head or dome 630 of the pin 624 against the expansive force or urging of the spring 632, thus closing drain valve 152. (See the views in FIG. 8 and FIG. 10). The clamp arms or tabs 720 are supported by the dissolvable band 724 (best seen in FIG. 7) situated within the bobbin 608. The dissolvable band 724 is positioned at an open end of the bobbin 608, towards the interior of ESS 112, so that band 724 may come into contact with any leaking fluid from ESS 112.

When the dissolvable band 724 comes into contact with leaking fluid, such as leaking coolant from ESS 112, the fluid dissolves dissolvable band 724 (or otherwise causes dissolvable band 724 to lose structural integrity) and the clamp arms or tabs 720 are no longer supported by dissolvable band 724. The tabs 720 may now flex and thus the pin 624 is free to move axially through the bobbin 608 as urged by the spring 632, resulting in the state (retracted position) shown in FIG. 9 and FIG. 11.

The movement of the pin 624 allows the entire piston assembly 612 to move as well, thereby opening the port on valve 152 allowing liquid to drain from ESS 112. Collar 628, which is initially spring loaded and restrained by bobbin 608, is in communication with a feature inside of flow outlet 640 when initially assembled, such that when the dome 630 becomes “retracted” upon triggering, the dome 630 becomes the feature that the spring 632 indirectly acts upon, through collar 628, to eject the piston assembly 612 from bushing 604. See FIG. 9 and FIG. 11. See also FIG. 12 and FIG. 13 where piston assembly 612 has been ejected from flow outlet 640 altogether.

As mentioned earlier, tether 616 is attached to piston assembly 612, passing through the interior channel 712 of bobbin 608, and can attach to the enclosure of drain valve 152 retain the piston assembly 612 even as liquid exits from flow outlet 640. See FIG. 12 and FIG. 13.

In view of the above it will now be apparent that variants, subsets and combinations are contemplated. For example, the hexagonal-periphery of flow outlet 640 is but one way to provide a means to affix and/or tighten bushing 604 to ESS 112. Also note that the “neutral” position of spring 632 in FIG. 9 and FIG. 11 may be referred to as a “non-compressed” or “expanded” or “less compressed” of “relaxed” position, in that spring 632 may still be under a certain amount of compression, but relatively less compression than the views shown in FIG. 8 and FIG. 10. Also, while spring 632 is implemented as a helical spring, other types of biasing members are contemplated such as a conical spring. Also, the plurality of keyed channels 708 and corresponding structure of threaded end 636 may be substituted with another type of anti-rotation structure, and in some embodiments, if the overall performance of drain valve 152 is adequate, omitted altogether including potential for rotation.

In general terms, crown 620 is for releasable sealing engagement with flow outlet 640, and this is a presently preferred embodiment for providing such releasable sealing engagement. Furthermore, collectively, bobbin 608 and piston assembly 612 are a type of ejector (aka ejection mechanism) for maintaining crown 620 within flow outlet 640. Notably, dissolvable band 724 is a liquid-sensitive medium that cooperates with the release. It will be understood that spring 632 is thus one type of biasing means that can cooperate with the liquid-sensitive medium and the release in order to maintain the crown 620 in the sealing engagement when the liquid-sensitive medium is dry to restrict fluid communication via the flow outlet and to release the crown 620 from being maintained in the sealing engagement when the liquid-sensitive medium is wet to allow fluid communication via the flow outlet 640.

Certain advantages according to the present specification will now occur to those skilled in the art. Notably, the flow rate of liquid from ESS 112 is relatively rapid when drain valve 152 is in the open position shown in FIG. 12 and FIG. 13, with piston assembly 612 ejected from bushing 604 and therefore not obstructing flow outlet 640 thereby reducing the risk of a critical incident by keeping coolant away from sensitive inner parts of ESS 112.

It should be recognized that features and aspects of the various examples provided above can be combined into further examples that also fall within the scope of the present disclosure. In addition, the figures are not necessarily to scale and may have size and shape exaggerated for illustrative purposes.

1. An assembly for a drain valve for an energy storage subsystem (ESS) comprising:
a crown for releasable sealing engagement within a flow outlet;
an ejector coupled to the crown;
a liquid-sensitive medium to cooperate with the ejector; and, a biasing means to cooperate with the liquid-sensitive medium and the ejector in order to:
maintain the crown in the sealing engagement when the liquid-sensitive medium is dry; and
release the crown from the sealing engagement when the liquid-sensitive medium is wet.

2. The assembly of claim 1 wherein the crown is ejectable from the flow outlet when released.

3. The assembly of claim 1 wherein the crown, ejector, liquid sensitive medium and biasing means are ejectable from the flow outlet when the crown is released.

4. The assembly of claim 1 wherein the ejector includes a pin depending from the crown having a dome on the end of the pin opposite from the crown.

5. The assembly of claim 4 wherein the ejector includes a bobbin surrounding the pin and having a diameter less than the dome in order to maintain the crown in sealing engagement; the liquid sensitive medium within a core of the bobbin; the bobbin including a plurality of tabs biased towards the periphery of the bobbin, such that when the liquid sensitive medium is dry the tabs secure the dome in order to maintain the crown, and when the liquid-sensitive medium is wet the medium loses structural integrity and the tabs bias towards the periphery and release the crown.

6. The assembly of claim 5 wherein the biasing means is a helical spring disposed around the pin and having a first end that abuts the crown.

7. The assembly of claim 6 wherein the ejector includes a collar slidable along the pin and retained between the dome and the spring.

8. The assembly of claim 7 wherein the spring has a compressed position to maintain the crown within the outlet and a less-compressed position to release the crown and at least partially eject the crown from the outlet.

9. The assembly of claim 7 wherein the dome has a retracted position in relation to the collar to release the crown and an extended position in relation to the collar to maintain the crown.

10. The assembly of claim 1 wherein the crown includes at least one O-ring for the sealing engagement.

11. The assembly of claim 1 wherein the flow outlet is part of a bushing that has a threaded end for securing the case of the ESS.

12. The assembly of claim 11 further comprising an O-ring on the periphery of the threaded end abutting the flow outlet.

13. The assembly of claim 1 further including a tether for securing at least the crown to the flow outlet upon ejection of the crown.

14. A method for draining coolant from an energy storage sub-system (ESS) comprising:
sealing a flow outlet in the ESS with a crown;
maintaining the crown within the flow outlet via an ejector cooperating with a liquid-sensitive medium;
releasing the crown from the flow outlet via the ejector upon detecting a coolant within the liquid-sensitive medium;
ejecting the crown from the flow outlet; and,
expelling coolant from the flow outlet without obstruction from the crown.

15. The method of claim 14 further comprising ejecting the ejector and expelling coolant without obstruction from the release.

16. The method of claim 15 wherein the ejector cooperates with a biasing means for the maintaining and the releasing.

17. The method 16 wherein the ejector includes a pin depending from the crown having a dome on the end of the pin opposite from the crown.

18. The method of claim 17 wherein the ejector includes a bobbin surrounding the pin and having a diameter less than dome in order to maintain the crown; the liquid sensitive medium within a core of the bobbin; the bobbin including a plurality of tabs biased towards the periphery of the bobbin, such that when the liquid sensitive medium is dry the tabs secure the dome in order to maintain the crown, and when the liquid-sensitive medium is wet the medium loses structural integrity and the tabs bias towards the periphery and release the crown.

19. The method of claim 14 further comprising securing the crown to the outlet with a tether.

20. A drain valve system for an energy storage sub-system (ESS) comprising:
a bushing having a mounting end for attachment to an ESS casing; the bushing having a flow outlet opposite the mounting end;
a piston assembly having a crown for releasable sealing engagement with the flow outlet;
a pin depending from the crown;
a dome at the end of the pin opposite the crown;
the piston assembly further having a helical spring surrounding the pin and disposed between the crown and the dome; the piston assembly further having a collar slidable along the pin and retained between the spring and the dome;
a toroidal bobbin disposed within the mounting end and having a liquid-sensitive medium in the core of the bobbin; the toroidal bobbin surrounding and securing the pin and dome and compressing the spring when the liquid-sensitive medium is dry; the toroidal bobbin releasing the dome and pin when the liquid-sensitive medium loses structural integrity when it becomes wet, allowing the spring to relax and unfastening the crown to unseal the flow outlet; and,
a tether for securing the piston assembly to the bushing when the piston assembly is ejected from the flow outlet and fluid flows via the flow outlet without obstruction by the piston assembly.
